(19) United States
(12) Patent Application Publication
(10) Pub. No.: US 2019/0364412 A1
(43) Pub. Date: Nov. 28, 2019

(54) APPARATUS AND METHOD FOR PDU SESSION ESTABLISHMENT RESTRICTION IN EMERGENCY REGISTRATION

(71) Applicant: MEDIATEK INC., Hsinchu (TW)

(72) Inventors: Chien-Chun HUANG-FU, Hsinchu (TW); Marko NIEMI, Oulu (FI)

(73) Assignee: MEDIATEK INC., Hsinchu (TW)

(21) Appl. No.: 16/421,078

(22) Filed: May 23, 2019

Related U.S. Application Data
(60) Provisional application No. 62/676,326, filed on May 25, 2018.

(51) Int. Cl. H04W 4/90; H04W 60/00; H04W 80/10; H04W 76/50; H04W 36/00

(52) U.S. Cl. CPC H04W 4/90; H04W 60/00; H04W 36/0022; H04W 76/50; H04W 80/10

(57) ABSTRACT

Aspects of the disclosure can provide an apparatus and method for performing protocol data unit (PDU) session establishment restriction in emergency registration in a fifth generation system (5GS). The apparatus comprises processing circuitry which is configured to detect whether user equipment (UE) is registered for emergency services via a first access type in the 5GS. When the UE is registered but without an established emergency PDU session, the processing circuitry is configured to establish a new emergency PDU session in the first access type. When the UE is registered and has the established emergency PDU session, the processing circuitry is configured to transfer the established emergency PDU session in the first access type to a second emergency PDU session in a second access type by performing a PDU session establishment procedure or a service request procedure to transfer the established emergency PDU session. In some examples, the processing circuitry is further configured to detect whether the UE has an established packet data network (PDN) connection for an emergency bearer service in a fourth generation (4G) system, perform an emergency PDU session establishment procedure with an existing emergency PDU session request type when the UE has the established PDN connection for the emergency bearer service, and transfer the established PDN connection for the emergency bearer service in the 4G system to an emergency PDU session in the 5GS.

### INCORPORATION BY REFERENCE

This present disclosure claims the benefit of U.S. Provisional Application No. 62/676,326, “PDU session establishment restriction in emergency registration in 5GS” filed on May 25, 2018, which is incorporated herein by reference in its entirety.

### TECHNICAL FIELD

The present disclosure relates to wireless communications, and specifically relates to Protocol Data Unit (PDU) session establishment restriction in emergency registration in the fifth generation system (5GS).

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The mobile communication system has grown exponentially over the years. The 3^{rd} generation partnership project (3GPP), which has developed the most successful standard technologies in mobile communication market such as Universal Mobile Telecommunication System (UMTS) and Long Term Evolution (LTE), is currently carrying out the standardization of the fifth generation (5G) system (5GS), which includes a core network and an access network. The access network can integrate different access types, e.g., 3GPP access and non-3GPP access. Specifically, a 3GPP access is a radio access technology (RAT) specified by the 3GPP, and a non-3GPP access is an access technology that is not specified by the 3GPP. The technologies for the 3GPP access can include Global System for Mobile communications (GSM), UMTS, LTE, 5G New Radio (NR) and the like. The technologies for the non-3GPP access can include Wi-Fi, Code-Division Multiple Access 2000 (CDMA2000), Worldwide Interoperability for Microwave Access (WiMAX), Digital Subscriber Line (DSL), and the like.

In a fourth generation (4G) system, such as an Evolved Packet System (EPS), user equipment (UE) can establish a Packet Data Network (PDN) connection during the UE is registered for an emergency bearer service. Therefore, when a PDN connection for the emergency bearer service has already been established, the UE cannot request an additional PDN connection for other services (e.g., another emergency bearer service and normal services). In contrast, when the UE is registered in a 5GS for an emergency service in a cell that can offer normal services (i.e., not in limited service state), the UE is not prevented of establishing a PDU session for normal services. In order to regulate the PDU session operations in the emergency registration in the 5GS, the UE can perform one or more PDU session establishment restrictions in the emergency registration.

### SUMMARY

Aspects of the disclosure provide an apparatus to perform Protocol Data Unit (PDU) session establishment restriction in emergency registration in a fifth generation system (5GS). The apparatus can include processing circuitry which is configured to detect whether user equipment (UE) is registered for emergency services via a first access type in the 5GS. When the UE is registered, but without an established emergency PDU session, the processing circuitry can be configured to establish a new emergency PDU session. When the UE is registered and has the established emergency PDU session, the processing circuitry can be configured to transfer the established emergency PDU session in the first access type to a second emergency PDU session in a second access type by performing a PDU session establishment procedure or a service request procedure.

In a further embodiment, the processing circuitry can be further configured to detect whether the UE has an established packet data network (PDN) connection for an emergency bearer service in a fourth generation (4G) system, perform an emergency PDU session establishment procedure with an existing emergency PDU session request type when the UE has the established PDN connection for the emergency bearer service, and transfer the established PDN connection for the emergency bearer service in the 4G system to an emergency PDU session in a 5GS.

In another embodiment, when the UE is registered for emergency services via the first access type, the processing circuitry of the apparatus can be configured to prevent a PDU session being established for normal services in the first access type.

In an embodiment, when the UE does not have an established emergency PDU session, the processing circuitry of the apparatus can be configured to perform an emergency PDU session establishment procedure with an initial emergency request type to establish a new emergency PDU session.

In an embodiment, when the UE transfers the established emergency PDU session in the first access type to the second emergency PDU session in the second access type, the processing circuitry of the apparatus can be configured to send an emergency PDU session establishment request with an existing emergency PDU session request type and transfer the established emergency PDU session from the first access type to the second access type.

In an alternative embodiment, when the UE transfers the established emergency PDU session in the first access type to the second emergency PDU session in the second access type, the processing circuitry of the apparatus can be further configured to perform a network triggered service request procedure or a UE triggered service request procedure to transfer the established emergency PDU session from the first access type to the second access type.

In an embodiment, when transferring the established emergency PDU session in the first access type to the second emergency PDU session in the second access type, the processing circuitry of the apparatus can be configured to transfer the established emergency PDU session in a 3GPP access to the second emergency PDU session in a non-3GPP access.

In another embodiment, when transferring the established emergency PDU session in the first access type to the second emergency PDU session in the second access type, the processing circuitry of the apparatus can be further configured to transfer the established emergency PDU session in a non-3GPP access to the second emergency PDU session in a 3GPP access.

Aspects of the disclosure can further provide a method for PDU session restriction in emergency registration, including detecting, by a processing circuitry of UE, whether the UE is registered for emergency services via a first access type, establishing a new emergency PDU session when the UE is registered, but without an established emergency PDU session, and transferring, when the UE is registered and has the established emergency PDU session in the first access type, the established emergency PDU session in the first access type to a second emergency PDU session in a second access type by performing a PDU session establishment procedure or a service request procedure.

In a further embodiment, the method can further include detecting whether the UE has an established PDN connection for an emergency bearer service in a 4G system, performing an emergency PDU session establishment procedure with an existing emergency PDU session request type, and transferring the established PDN connection for the emergency bearer service in the 4G system to an emergency PDU session in a 5GS.

In another embodiment, detecting whether the UE is registered for emergency services via the first access type in the wireless communication system can include preventing a PDU session being established for normal services in the first access type when the UE is registered for emergency services.

In an embodiment, establishing the new emergency PDU session can include performing an emergency PDU session establishment procedure with an initial emergency request type when the UE does not have the established emergency PDU session.

In an embodiment, transferring the established emergency PDU session in the first access type to the second emergency PDU session in the second access type can include sending an emergency PDU session establishment request with an existing emergency PDU session request type and transferring the established emergency PDU session from the first access type to the second access type.

In an alternative embodiment, transferring the established emergency PDU session in the first access type to the second emergency PDU session in the second access type can further include performing a network triggered service request procedure or a UE triggered service request procedure to transfer the established emergency PDU session from the first access type to the second access type.

In an embodiment, transferring the first established emergency PDU session to the second emergency PDU session can include transferring the established emergency PDU session in a non-3GPP access to the second emergency PDU session in a 3GPP access.

In another embodiment, transferring the first established emergency PDU session to the second emergency PDU session can further include transferring the established emergency PDU session in a 3GPP access to the second emergency PDU session in a non-3GPP access.

Aspects of the disclosure can further provide a non-transitory computer readable medium storing instructions which, when executed by a processor, cause the processor to detect whether the UE is registered for emergency services via a first access type, establish a new emergency PDU session when the UE is registered, but without an established emergency PDU session, and transfer, when the UE is registered and has the established emergency PDU session in the first access type, the established emergency PDU session in the first access type to a second emergency PDU session in a second access type by performing a PDU session establishment procedure or a service request procedure.

Further embodiments of the disclosure can provide a non-transitory computer readable medium storing instructions which, when executed by a processor, cause the processor to detect whether the UE has an established PDN connection for an emergency bearer service in a 4G system, performing an emergency PDU session establishment procedure with an existing emergency PDU session request type, and transferring the established PDN connection for the emergency bearer service in the 4G system to an emergency PDU session in a 5GS.

In an embodiment, the non-transitory computer readable medium stores instructions which, when executed by a processor, can cause the processor to prevent a PDU session being established for normal services in the first access type when the UE is registered for emergency services.

In an embodiment, the non-transitory computer readable medium stores instructions which, when executed by a processor, may cause the processor to perform an emergency PDU session establishment procedure with an initial emergency request type when the UE does not have the established emergency PDU session.

In an embodiment, the non-transitory computer readable medium stores instructions which, when executed by a processor, can cause the processor to send an emergency PDU session establishment request with an existing emergency PDU session request type and transfer the established emergency PDU session from the first access type to the second access type.

In an alternative embodiment, the non-transitory computer readable medium stores instructions which, when executed by a processor, can cause the processor to perform a network triggered service request procedure or a UE triggered service request procedure to transfer the established emergency PDU session from the first access type to the second access type.

In an embodiment, the non-transitory computer readable medium stores instructions which, when executed by a processor, can cause the processor to transfer the established emergency PDU session in a 3GPP access to the second emergency PDU session in a non-3GPP access.

In another embodiment, the non-transitory computer readable medium stores instructions which, when executed by a processor, can further cause the processor to transfer the established emergency PDU session in a non-3GPP access to the second emergency PDU session in a 3GPP access.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary wireless communication system according to an embodiment of the disclosure;

FIG. 2 is a flowchart showing an exemplary process wherein a UE establishes an emergency PDU session according to an embodiment of the disclosure;

FIG. 3 is a flowchart showing an exemplary process wherein a UE transfers an established emergency PDU session according to an embodiment of the disclosure;

FIG. 4 shows an exemplary PDU session transfer procedure according to an embodiment of the disclosure;

FIG. 5 is a flowchart showing another exemplary process wherein a UE transfers an established emergency PDU session according to an embodiment of the disclosure;

FIG. 6 shows another exemplary PDU session transfer procedure according to an embodiment of the disclosure;

FIG. 7 is a flowchart showing an exemplary process wherein a UE transfers an established PDN connection according to an embodiment of the disclosure; and

FIG. 8 shows an exemplary block diagram of a UE according to an embodiment of the disclosure.

### DETAILED DESCRIPTION OF EMBODIMENTS

Aspects of the disclosure provide an apparatus and a method for performing Protocol Data Unit (PDU) session establishment restriction in emergency registration in a fifth generation system (5GS). When user equipment (UE) is registered for the emergency services and is camping on a cell that can provide normal services, the UE can establish a PDU session without restriction. For example, the UE can register for emergency services and establish a PDU session for normal services. In order to restrict the UE's PDU session establishment in emergency registration, so that the UE can only establish emergency PDU sessions when it is registered for emergency services, the processing circuitry of the apparatus (e.g., UE) can be configured to detect whether the UE is registered for emergency services in the 5GS. When the UE is registered, but without an established emergency PDU session, the processing circuitry of the apparatus can be configured to establish a new emergency PDU session.

In some examples, when the UE is registered via a first access type and has the established emergency PDU session in the first access type, the processing circuitry of the apparatus can be configured to transfer the established emergency PDU session from the first access type to a second access type. Herein, the first access type can be a non-3GPP access and the second access type can be a 3GPP access, or the first access type can be a 3GPP access and the second access type can be a non-3GPP access.

In some other examples, when the UE is registered and has an established Packet Data Network (PDN) connection for an emergency bearer service in a fourth generation (4G) system, the processing circuitry of the apparatus can be further configured to transfer the PDN connection for the emergency bearer service to an emergency PDU session in the 5GS.

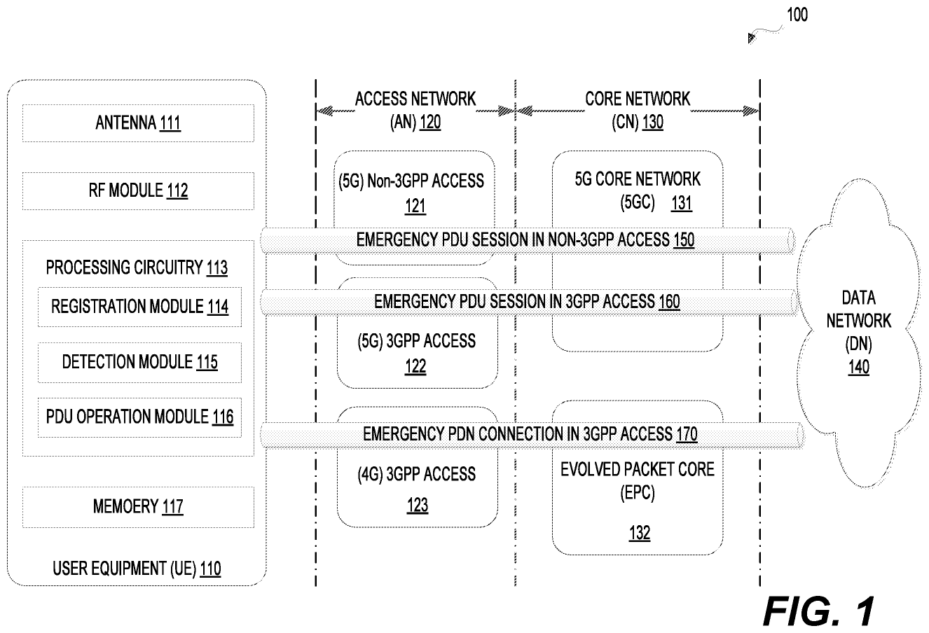

FIG. 1 shows an exemplary wireless communication system 100 according to an embodiment of the disclosure. As shown, the wireless communication system 100 can include a UE 110, an access network (AN) 120, a core network (CN) 130, and a data network (DN) 140. For purposes of clarity in this description, both a 5GS and a 4G system, such as an Evolved Packet System (EPS), are illustrated in the FIG. 1.

The UE 110 can be any apparatus or network element in the wireless communication system 100 capable of signal transmission and reception. For example, the UE 110 can be a mobile phone, a laptop computer, a tablet, a vehicle carried communication device, a utility meter fixed at a certain location, a commercial product with wireless communication capability, and the like. While only one UE 110 is depicted in the FIG. 1, it should be understood that any number UEs 110 can be distributed in the wireless communication system 100.

As shown in the FIG. 1 example, the UE 110 can include an antenna 111, an RF module 112, a processing circuitry 113, and a memory 117. The antenna 111 can include one or more antenna arrays to propagate and intercept radio waves in space. The RF module 112 can process digital and analog signals, and transmit/receive wireless signals. The processing circuitry 113 can include circuitry configured to perform the functions and processes in combination with or without software. The memory 117 can be any device or material that can store and retrieve electronic data, such as operating systems, program instructions, and the like. It can include a read only memory (ROM), a random access memory (RAM), a flash memory, a solid state memory, a hard disk drive, an optical disk drive, and the like.

In the present disclosure, the processing circuitry 113 can further include a registration module 114, a detection module 115, and a PDU operation module 116. The registration module 114 can perform UE registration by executing the program instructions stored in the memory 117 to register the UE 110 for emergence services (i.e., limited service state) or normal services (i.e., not in limited service state) via a access type.

The detection module 115 can execute the program instructions stored in the memory 117 to detect the UE's registration type, e.g., emergency or normal, and PDU request type, e.g., “initial emergency request”, “existing emergency PDU session”, “initial request”, or “existing PDU session”. Similarly, the PDU operation module 116 can execute the program instructions (e.g., establishment, modification, and release) stored in the memory 117 to perform PDU operations, such as establishing a new PDU session and transferring an existing PDU session from one access to another.

It should be understood that the processing circuitry 113 of the UE 110 can include any other modules which can implement any other functionalities by executing the program instructions stored in the memory 117.

The AN 120 is part of the wireless communication system 100 that implements access technologies. It resides between the UE 110 and the CN 130. In general, the access technologies implemented in the AN 120 can be categorized into two types: 3GPP access and non-3GPP access. A 3GPP access is a radio access technology (RAT) specified by the 3GPP, and a non-3GPP access is an access technology that is not specified by the 3GPP. Exemplary technologies for 3GPP access can include Global System for Mobile communications (GSM), Universal Mobile Telecommunication System (UMTS), Long Term Evolution (LTE), 5G New Radio (NR) and the like. Exemplary technologies for non-3GPP access can include Wi-Fi, Code-Division Multiple Access 2000 (CDMA2000), Worldwide Interoperability for Microwave Access (WiMAX), Digital Subscriber Line (DSL), and the like. In the FIG. 1 example, the AN 120 includes a 5G non-3GPP access 121, a 5G 3GPP access 122, and a 4G 3GPP access 123.

The CN 130 is another part of the wireless communication system 100 that provides service management and delivery over wireless, fixed, or converged networks. As shown, the CN 130 can be a 5G CN (5GC) 131 for the 5GS or an Evolved Packet Core (EPC) 132 for the EPS. For example, when emergency service is required and an emergency PDU session is not established yet, the UE 110 can initiate a UE requested PDU session establishment procedure with an initial emergency request type and send the request to the 5GC 131. Then the 5GC 131 can handle the PDU session establishment request and further establish an emergency PDU session for the UE 110.

The DN 140 is a digital network that can provide different Internet services and applications to the UE 110. The Internet services and applications can be access to World Wide Web (WWW), digital video, digital audio, cloud storage and server, the use of email and instant message (IM) applications, and the like. For example, the DN 140 can provide the Internet services and applications to the UE 110 through one or more PDN connection(s) 170 in the EPS and one or more PDU session(s) 150-160 in the 5GS.

In operation, the UE 110 can register in a 5GS for emergency services via a non-3GPP access 121 or a 3GPP access 122. In the FIG. 1 example, when the UE 110 is in limited service status, the processing circuitry 113 of the UE 110 can trigger the registration module 114 to execute the program instructions stored in the memory 117 to initiate a registration procedure by indicating that the registration is to receive emergency services. Specifically, the processing circuitry 113 can generate a registration request for the emergency services in the 5GS. Then the RF module 112 can process the registration request and convert it to analog signals. The antenna 111 can transmit the analog signals as wireless signals via the non-3GPP access 121 or the 3GPP access 122. For example, the non-3GPP access 121 can be a Wi-Fi network and the 3GPP access 122 can be a 5G NR access network. The 5GC 131 can receive the registration request and decide to accept or reject the registration from the UE 110. When the 5GC 131 accepts the registration request from the UE 110, the UE 110 can be successfully registered for the emergency services in the 5GS.

Similarly, the UE 110 can also register for normal services in the 5GS via the non-3GPP access 121 or the 3GPP access 122.

Further, the UE 110 can detect whether it is registered for emergency services and detect which kind of PDU session establishment request type is set for the UE 110. For example, the processing circuitry 113 of the UE 110 can trigger the detection module 115 to execute the program instructions stored in the memory 117 to check whether the UE 110 is registered for the emergency service or not.

In an embodiment, when the UE 110 is detected to be registered for emergency services, but without an established emergency PDU session. The UE can establish a new emergency PDU session. For example, when the UE 110 is registered for emergency services but without an established emergency PDU session, the processing circuitry 113 of the UE 110 can trigger the PDU operation module 116 to execute the program instructions stored in the memory 117 to perform an emergency PDU session establishment procedure to establish a new PDU session for emergency services.

In particular, the PDU operation module 116 can generate a PDU session establishment request with an initial emergency request type (e.g., request type is set to “initial emergency request”), which indicates the emergency PDU session establishment request is to establish a new PDU session for emergency services. The RF module 112 can further process the PDU session establishment request and transmit the PDU session establishment request via the antenna 111 in the non-3GPP access 121 or the 3GPP access 122. The 5GC 131 can then receive the PDU session establishment request and establish the emergency PDU session for the UE 110. As shown in the FIG. 1, the established emergency PDU session can be the emergency PDU session 150 in the non-3GPP access 121, or the emergency PDU session 160 in the 3GPP access 122.

In another embodiment, when the UE 110 is detected to be registered for emergency services via a first access type and has an established emergency PDU session, the UE can transfer the established emergency PDU session from the first access type to a second access type. For example, when the UE 110 is registered for emergency services via the 5G non-3GPP access 121 and has an established emergency PDU session 150 in the 5G non-3GPP access 121, the processing circuitry 113 of the UE 110 can trigger the registration module 114 to register in the 5G 3GPP access 122. Then the processing circuitry 113 can trigger the PDU operation module 116 to execute the program instructions stored in the memory 117 to transfer the established emergency PDU session from the 5G non-3GPP access (e.g., Wi-Fi) 121 to the 5G 3GPP access (e.g., 5G NR) 122.

In particular, the PDU operation module 116 can generate a PDU session establishment request with an existing emergency PDU session request type (e.g., request type is set to “existing emergency PDU session”), which indicates the emergency PDU session establishment request is to transfer the established emergency PDU session 150 in the 5G non-3GPP access 121 to an emergency PDU session 160 in the 5G 3GPP access 122. The RF module 112 can further process the PDU session establishment request and transmit the PDU session establishment request via the antenna 111 in the non-3GPP access 121. The 5GC 131 can receive the PDU session establishment request and transfer the emergency PDU session 150 in the 5G non-3GPP access 121 to the emergency PDU session 160 in the 5G 3GPP access 122.

In some other examples, the UE 110 can trigger the PDU operation module 116 to perform a service request procedure to transfer the established emergency PDU session 150 in the 5G non-3GPP access 121 to the emergency PDU session 160 in the 5G 3GPP access 122. The service request procedure can be triggered by the UE 110 or by the network (e.g., CN 130).

Similarly, when the UE 110 is registered for emergency services and has an established emergency PDU session 160 in the 5G 3GPP access 122, the processing circuitry 113 of the UE 110 can trigger the PDU operation module 116 to execute the program instructions stored in the memory 117 to transfer the emergency PDU session 160 in the 3GPP access 122 to the emergency PDU session 150 in the non-3GPP access 121.

In an embodiment, when the UE 110 is detected to be registered for emergency services and has an established PDN connection for an emergency bearer service in a 4G system (e.g., an EPS). The UE can transfer the established PDN connection for the emergency bearer service in the EPS to an emergency PDU session in the 5GS.

For example, when the UE 110 is registered for emergency services and has an established PDN connection 170 for an emergency bearer service in a 4G 3GPP access 123 (e.g., LTE), the processing circuitry 113 of the UE 110 can trigger the PDU operation module 116 to execute the program instructions stored in the memory 117 to transfer the established PDN connection 170 for the emergency bearer service in the 4G 3GPP access 123 to an emergency PDU session 160 in the 5G 3GPP access (e.g., 5G NR) 122.

Specifically, the PDU operation module 116 can generate a PDU session establishment request with an existing emergency PDU session request type (e.g., request type is set to “existing emergency PDU session”), which indicates the emergency PDU session establishment request is to transfer the emergency PDN connection 170 for the emergency bearer service in the 4G 3GPP access 123 to the emergency PDU session 160 in the 5G 3GPP access 122. The RF module 112 can further process the PDU session establishment request and transmit the PDU session establishment request via the antenna 111 in the 4G 3GPP access 123. The 5GC 131 and the EPC 132 can receive the PDU session establishment request and work together to transfer the established PDN connection 170 for the emergency bearer service in the 4G 3GPP access 123 to the emergency PDU session 160 in the 5G 3GPP access 122.

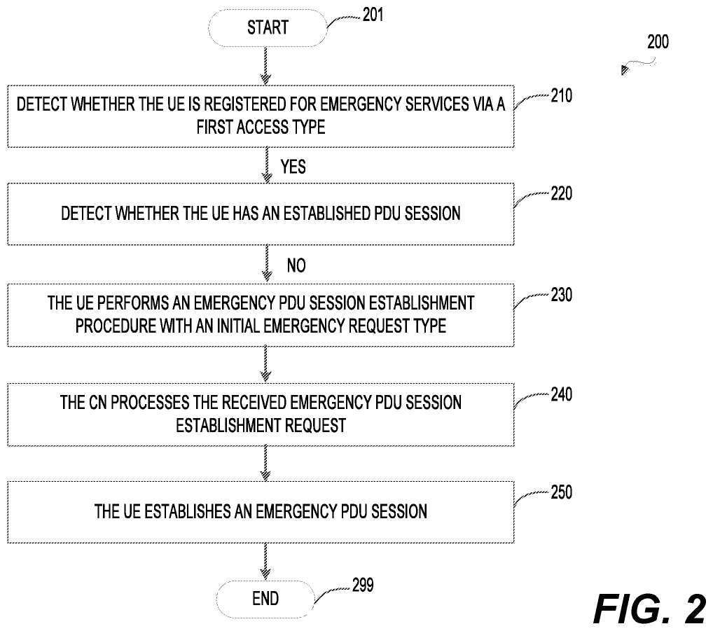

FIG. 2 is a flowchart showing an exemplary PDU session establishment process 200 according to an embodiment of the disclosure. In the FIG. 2 example, the PDU session establishment process 200 can be performed on the UE in a 5GS and start from 201 to proceed to 210.

At 210, the UE can detect whether the UE is registered for the emergency services via a first access type. For example, as shown in the FIG. 1 example, the processing circuitry 113 of the UE 110 can trigger the detection module 115 to check whether the UE 110 is registered for the emergency services via a first access type in the 5GS. If yes, the process 200 can then proceed to 220. If not, the processing circuitry 113 of the UE 110 can further trigger the registration module 114 to register the UE 110 via the first access type in the 5GS. Herein, the first access type can be a non-3GPP access 121 or a 3GPP access 121. Then the process 200 can proceed to 220.

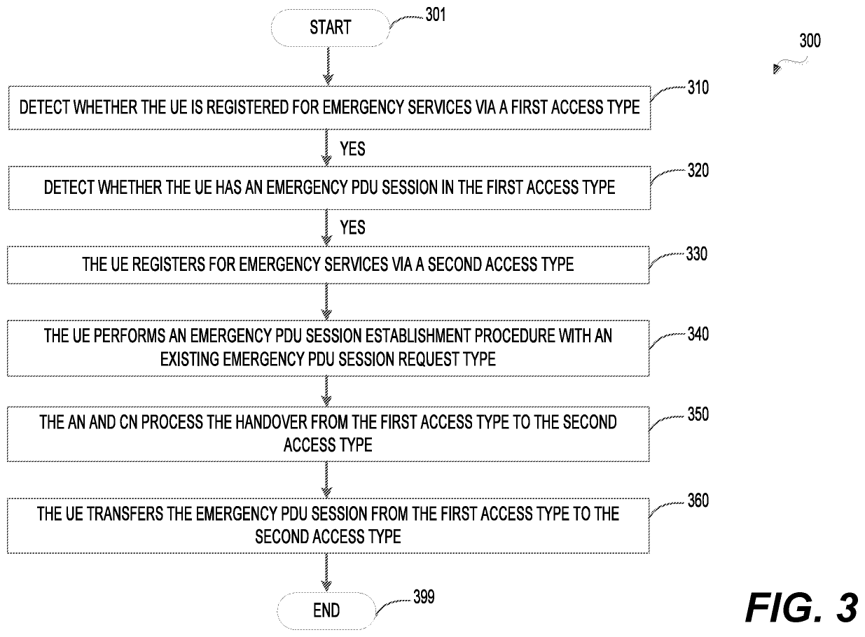

At 220, when the UE is registered for the emergency services, the UE can further detect whether the UE has an established PDU session in the first access type. For example, as shown in the FIG. 1 example, the processing circuitry 113 of the UE 110 can trigger the detection module 115 to detect whether the UE 110 has an established PDU session in the first access type by executing the program instructions stored in the memory 117. When the UE 110 does not have the established PDU session, the process 200 can then proceed to 230. When the UE 110 has the established PDU session, the UE 110 can further transfer the established PDU session which is illustrated in the FIGS. 3-6.

At 230, the UE can perform an emergency PDU session establishment procedure when the UE is detected to be registered for the emergency services but without an established PDU session. For example, as shown in the FIG. 1, the processing circuitry 113 of the UE 110 can trigger the PDU operation module 116 to execute the program instructions stored in the memory 117 to perform an emergency PDU session establishment procedure.

In particular, the PDU operation module 116 can generate a PDU session establishment request with an initial emergency request type (e.g., request type is set to “initial emergency request”), which indicates the emergency PDU session establishment request is to establish a new PDU session for emergency services. The RF module 112 can further process the PDU session establishment request and transmit the PDU session establishment request via the antenna 111 in the non-3GPP access 121 or the 3GPP access 122. The process 200 can then proceed to 240.

At 240, the AN can receive the PDU session establishment request and forward it to the CN. Upon the reception of the PDU session establishment request from the UE, the CN can process the PDU session establishment request. For example, as shown in the FIG. 1, upon the reception of PDU session establishment request, the 5GC 131 can process the PDU session establishment request from the UE 110. The 5GC 131 can work with the AN 120 to accept (or reject) the PDU session establishment request from the UE 110. The process 200 can then proceed to 250.

At 250, the UE can establish an emergency PDU session in the first access type. For example, as shown in the FIG. 1, when the 5GC 131 accepts the PDU session establishment request from the UE 110, the UE 110 can establish an emergency PDU session in the first access type. Herein, the first access type can be either a non-3GPP access 121 or a 3GPP access 122. Therefore, the established emergency PDU session can be the emergency PDU session 150 in the non-3GPP access 121, or the emergency PDU session 160 in the 3GPP access 122. Then the process 200 can proceed to 299 and terminate.

FIG. 3 is a flowchart showing an exemplary PDU session transfer process 300 according to an embodiment of the disclosure. The UE can transfer an established emergency PDU session from a first access type to a second access type by performing a PDU session establishment procedure. In the FIG. 3 example, the first access type can be a non-3GPP access and the second access type can be a 3GPP access. It should be understood that the first access type can be also a 3GPP access and the second access type can be a non-3GPP access. The process 300 can start from 301 and proceed to 310.

At 310, the UE can detect whether the UE is registered for the emergency services via the first access type. For example, as shown in the FIG. 1 example, the processing circuitry 113 of the UE 110 can trigger the detection module 115 to check whether the UE 110 is registered for the emergency services via the 5G non-3GPP access 121 in the 5GS. If yes, the process 300 can then proceed to 320. If not, the processing circuitry 113 of the UE 110 can trigger the registration module 114 to register the UE 110 for the emergency services via the 5G non-3GPP access 121 in the 5GS. Then the process 300 can proceed to 320.

At 320, when the UE is registered for the emergency services, the UE can further detect whether the UE has an established emergency PDU session in the first access type. For example, as shown in the FIG. 1 example, the processing circuitry 113 of the UE 110 can trigger the detection module 115 to detect whether the UE 110 has an established PDU session in the 5G non-3GPP access 121 by executing the program instructions stored in the memory 117. When the UE 110 has the established emergency PDU session in the 5G non-3GPP access 121, the process 300 can then proceed to 330.

At 330, the UE can register for emergency services via the second access type. For example, as shown in the FIG. 1, the processing circuitry 113 of the UE 110 can trigger the registration module 114 to execute the program instructions stored in the memory 117 to register the UE 110 for the emergency services via the 5G 3GPP access 122. Then the process 300 can proceed to 340.

At 340, when the UE is registered for the emergency services and has the established emergency PDU session in the 5G non-3GPP access, the UE can transfer the established emergency PDU session from the 5G non-3GPP access to the 5G 3GPP access by performing an emergency PDU session establishment procedure. For example, as shown in the FIG. 1, the processing circuitry 113 can trigger the PDU operation module 116 to execute the program instructions stored in the memory 117 to perform the emergency PDU session establishment procedure to transfer the established emergency PDU session 150 in the 5G non-3GPP access 121 to the second emergency PDU session 160 in the 5G 3GPP access 122.

Particularly, the PDU operation module 116 can generate a PDU session establishment request with an existing emergency PDU session request type (e.g., request type is set to “existing emergency PDU session”), which indicates the PDU session establishment request is to transfer the established emergency PDU session from the 5G non-3GPP access 121 to the 5G 3GPP access 122. The RF module 112 can further process the PDU session establishment request and transmit the PDU session establishment request via the antenna 111 as wireless signals. The process 300 can then proceed to 350.

At 350, the AN can receive the PDU session establishment request and forward it to the CN. Upon the reception of the PDU session establishment request from the UE, the CN can process the PDU session establishment request with the AN. For example, as shown in the FIG. 1, upon the reception of PDU session establishment request, the 5GC 131 can work with the AN 120 to perform PDU session switching between the 5G non-3GPP access 121 and the 5G 3GPP access 122. The process 300 can then proceed to 360.

At 360, the UE can transfer the established emergency PDU session from the 5G non-3GPP access to the 5G 3GPP access. For example, as shown in the FIG. 1, when the 5GC 131 accepts the PDU session establishment request from the UE 110 and finishes the PDU session switching with the AN 120, the UE 110 can transfer the established emergency PDU session 150 in the 5G non-3GPP access 121 to the second emergency PDU session 160 in the 5G 3GPP access 122. The process 300 can then proceed to 399 and terminate.

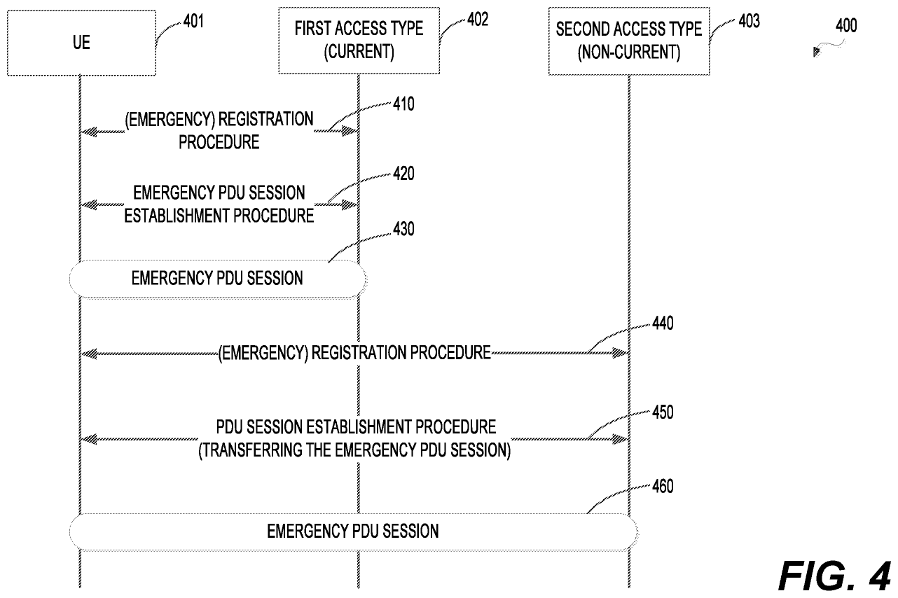

FIG. 4 shows an exemplary PDU session transfer procedure 400 according to an embodiment of the disclosure. The UE 401 can establish an emergency PDU session in a first access type 402 and further transfer the established emergency PDU session from the first access type 402 to a second access type 403 by performing a PDU session establishment procedure. In the FIG. 4 example, the first access type 402 can be a non-3GPP access and it is regarded as the current access type. The second access type 403 can be a 3GPP access and it is regarded as the non-current access type. It should be understood that the first access type 402 can also be a 3GPP access and the second access type 403 can be a non-3GPP access. The procedure 400 can include stages 410, 420, 430, 440, 450, and 460.

At stage 410, the UE 401 can register for emergency services via the first access type 402. For example, as shown in the FIG. 1 example, the processing circuitry 113 of the UE 110 can trigger the registration module 114 to register the UE 110 for emergency services via the 5G non-3GPP access 121 in the 5GS.

At stage 420, the UE 401 can perform emergency PDU session establishment procedure in the first access type 402. For example, as shown in the FIG. 1, the processing circuitry 113 of the UE 110 can trigger the PDU operation module 116 to execute the program instructions stored in the memory 117 to perform an emergency PDU session establishment procedure. In particular, the PDU operation module 116 can generate a PDU session establishment request with an initial emergency request type (e.g., request type is set to “initial emergency request”), which indicates the emergency PDU session establishment request is to establish a new PDU session for emergency services. The RF module 112 can further process the PDU session establishment request and transmit the PDU session establishment request via the antenna 111 in the non-3GPP access 121.

At stage 430, the UE 401 can successfully establish the emergency PDU session in the first access type 402. For example, as shown in the FIG. 1, when the 5GC 131 accepts the PDU session establishment request from the UE 110 and the emergency PDU session establishment procedure is completed, the UE 110 can have the emergency PDU session 150 in the non-3GPP access 121.

At stage 440, the UE 401 can register for emergency services via the second access type 403. For example, as shown in the FIG. 1 example, the processing circuitry 113 of the UE 110 can trigger the registration module 114 to register the UE 110 for emergency services via the 5G 3GPP access 122 in the 5GS.

At stage 450, the UE 401 can transfer the established emergency PDU session from the first access type 402 to the second access type 403 by performing the PDU session establishment procedure. For example, as shown in the FIG. 1, the processing circuitry 113 of the UE 110 can trigger the PDU operation module 116 to execute the program instructions stored in the memory 117 to perform the PDU session establishment procedure. In particular, the PDU operation module 116 can generate a PDU session establishment request with existing emergency PDU session request type (e.g., request type is set to “existing emergency PDU session”), which indicates the PDU session establishment request is to transfer the established emergency PDU session from the 5G non-3GPP access 121 to the 5G 3GPP access 122. The RF module 112 can further process the PDU session establishment request and transmit the PDU session establishment request via the antenna 111 in the non-3GPP access 121. Upon the reception of the PDU session establishment request from the UE 110, the CN 130 can process the PDU session establishment request with the AN 120.

At stage 460, the UE 401 can successfully transfer the established emergency PDU session from the first access type 402 to the second access type 403. For example, as shown in the FIG. 1, when the PDU session establishment procedure is completed, the UE 110 can transfer the emergency PDU session 150 in the non-3GPP access 121 to the emergency PDU session 160 in the non-3GPP access 122.

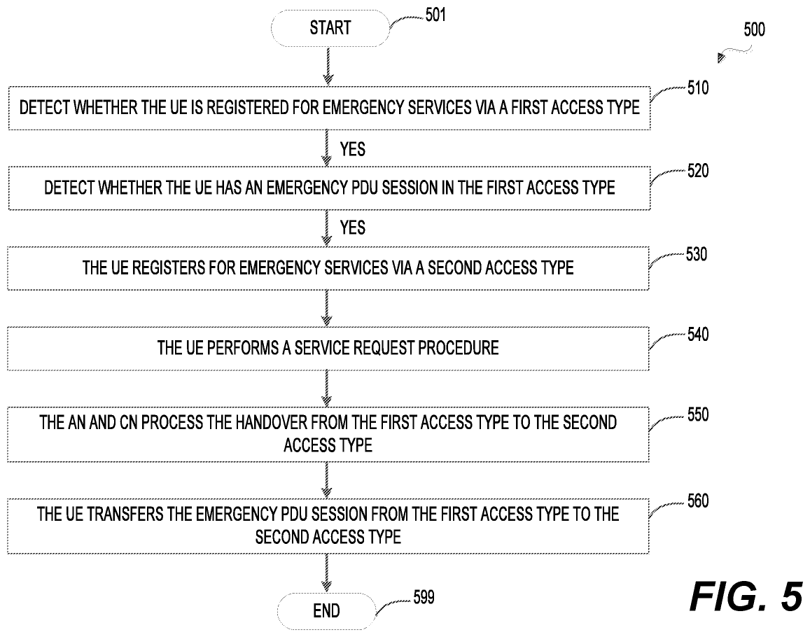

FIG. 5 is a flowchart showing another exemplary PDU session transfer process 500 according to an embodiment of the disclosure. The UE 110 can transfer an established emergency PDU session from a first access type to a second access type by performing a service request procedure. The service request procedure can be a UE triggered service request procedure or a network (e.g., CN) triggered service request procedure. In the FIG. 5 example, the first access type can be a non-3GPP access and the second access type can be a 3GPP access. It should be understood that the first access type can also be a 3GPP access and the second access type can be a non-3GPP access. The process 500 can start from 501 and proceed to 510.

At 510, the UE can detect whether the UE is registered for the emergency services via the first access type. For example, as shown in the FIG. 1 example, the processing circuitry 113 of the UE 110 can trigger the detection module 115 to check whether the UE 110 is registered for the emergency services via the 5G non-3GPP access 121 in the 5GS. If yes, the process 500 can then proceed to 520. If not, the processing circuitry 113 of the UE 110 can trigger the registration module 114 to register the UE 110 for the emergency services via the 5G non-3GPP access 121 in the 5GS. Then the process 500 can proceed to 520.

At 520, when the UE is registered for the emergency services, the UE can further detect whether the UE has an established emergency PDU session in the first access type. For example, as shown in the FIG. 1 example, the processing circuitry 113 of the UE 110 can trigger the detection module 115 to detect whether the UE 110 has an established PDU session in the 5G non-3GPP access 121 by executing the program instructions stored in the memory 117. When the UE 110 has the established emergency PDU session in the 5G non-3GPP access 121, the process 500 can then proceed to 530.

At 530, the UE can register for emergency services via the second access type. For example, as shown in the FIG. 1, the processing circuitry 113 of the UE 110 can trigger the registration module 114 to execute the program instructions stored in the memory 117 to register the UE 110 via the 5G 3GPP access 122. Then the process 500 can proceed to 540.

At 540, when the UE is detected to be registered for the emergency services and has the established emergency PDU session in the 5G non-3GPP access, the UE can transfer the established emergency PDU session from the 5G non-3GPP access to the 5G 3GPP access by performing the service request procedure. The service request procedure can be triggered by the UE or by the network (e.g., CN). For example, as shown in the FIG. 1, the processing circuitry 113 of the UE 110 can trigger the PDU operation module 116 to execute the program instructions stored in the memory 117 to perform the service request procedure to transfer the established emergency PDU session 150 in the 5G non-3GPP access 121 to the second emergency PDU session 160 in the 5G 3GPP access 122.

Particularly, the PDU operation module 116 can generate a service request message to perform the service request procedure for transferring the established emergency PDU session from the 5G non-3GPP access 121 to the 5G 3GPP access 122. The RF module 112 can further process the service request message and transmit the service request message via the antenna 111 as wireless signals. The process 500 can then proceed to 550.

At 550, the AN can receive the service request message and forward it to the CN. Upon the reception of the service request message from the UE, the CN can process the emergency PDU session transfer operation with the AN. For example, as shown in the FIG. 1, upon the reception of the service request message from the UE 110, the 5GC 131 can work with the AN 120 to perform PDU session switching between the 5G non-3GPP access 121 and the 5G 3GPP access 122. The process 500 can then proceed to 560.

At 560, the UE can transfer the established emergency PDU session from the 5G non-3GPP access to the 5G 3GPP access. For example, as shown in the FIG. 1, when the 5GC 131 finishes the PDU session switching with the AN 120, the UE 110 can transfer the established emergency PDU session 150 in the 5G non-3GPP access 121 to the second emergency PDU session 160 in the 5G 3GPP access 122. The process 500 can then proceed to 599 and terminate.

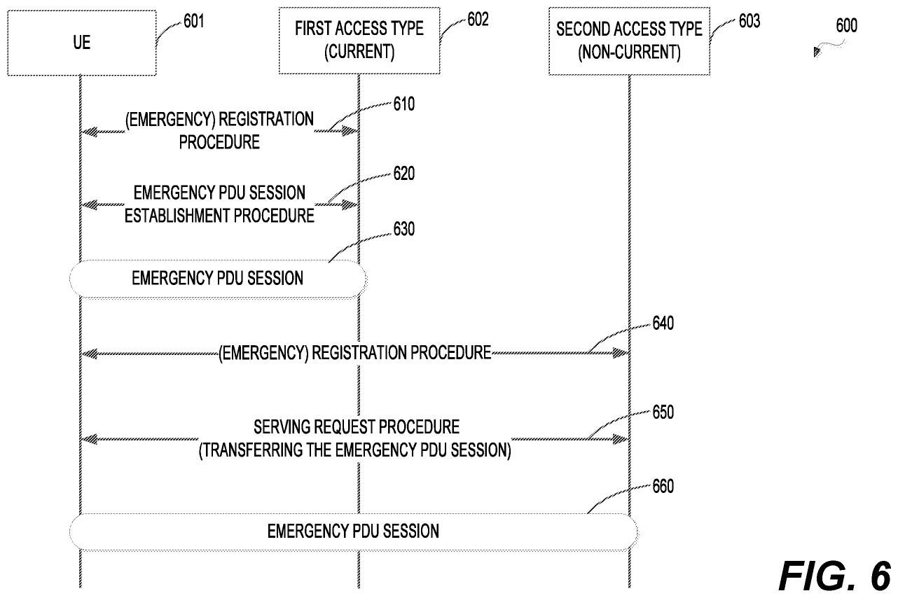

FIG. 6 shows an exemplary PDU session transfer procedure 600 according to an embodiment of the disclosure. The UE 601 can establish an emergency PDU session in a first access type 602 and further transfer the established emergency PDU session from the first access type 602 to a second access type 603 by performing a service request procedure. In the FIG. 6 example, the first access type 602 can be a non-3GPP access and it is regarded as the current access type. The second access type 603 can be a 3GPP access it is regarded as the non-current access type. It should be understood that the first access type 602 can also be a 3GPP access and the second access type 603 can be a non-3GPP access. The procedure 600 can include stages 610, 620, 630, 640, 650, and 660.

At stage 610, the UE 601 can register for emergency services via the first access type 602. For example, as shown in the FIG. 1 example, the processing circuitry 113 of the UE 110 can trigger the registration module 114 to execute the program instructions stored in the memory 117 to register the UE 110 for emergency services via the 5G non-3GPP access 121 in the 5GS.

At stage 620, the UE 601 can perform emergency PDU session establishment procedure in the first access type 602. For example, as shown in the FIG. 1, the processing circuitry 113 of the UE 110 can trigger the PDU operation module 116 to execute the program instructions stored in the memory 117 to perform an emergency PDU session establishment procedure. In particular, the PDU operation module 116 can generate a PDU session establishment request with an initial emergency request type (e.g., request type is set to “initial emergency request”), which indicates the emergency PDU session establishment request is to establish a new PDU session for emergency services. The RF module 112 can further process the PDU session establishment request and transmit the PDU session establishment request via the antenna 111 in the non-3GPP access 121.

At stage 630, the UE 601 can successfully establish the emergency PDU session in the first access type 602. For example, as shown in the FIG. 1, when the 5GC 131 accepts the PDU session establishment request from the UE 110 and the emergency PDU session establishment procedure is completed, the UE 110 can have an emergency PDU session 150 in the non-3GPP access 121.

At stage 640, the UE 601 can register for emergency services via the second access type 603. For example, as shown in the FIG. 1 example, the processing circuitry 113 of the UE 110 can trigger the registration module 114 to execute the program instructions stored in the memory 117 to register the UE 110 for emergency services via the 5G 3GPP access 122 in the 5GS.

At stage 650, the UE 601 can transfer the established emergency PDU session from the first access type 602 to the second access type 603 by performing the service request procedure. For example, as shown in the FIG. 1, the processing circuitry 113 of the UE 110 can trigger the PDU operation module 116 to execute the program instructions stored in the memory 117 to perform the service request procedure. In particular, the PDU operation module 116 can generate a service request message to perform the service request procedure for transferring the established emergency PDU session from the 5G non-3GPP access 121 to the 5G 3GPP access 122. The RF module 112 can further process the service request message and transmit the service request message via the antenna 111 as wireless signals. Upon the reception of the service request message from the UE 110, the CN 130 can process the emergency PDU session transfer operation with the AN 120.

At stage 660, the UE 601 can successfully transfer the established emergency PDU session from the first access type 602 to the second access type 603. For example, as shown in the FIG. 1, when the service request procedure is completed, the UE 110 can transfer the emergency PDU session 150 in the non-3GPP access 121 to the emergency PDU session 160 in the non-3GPP access 122.

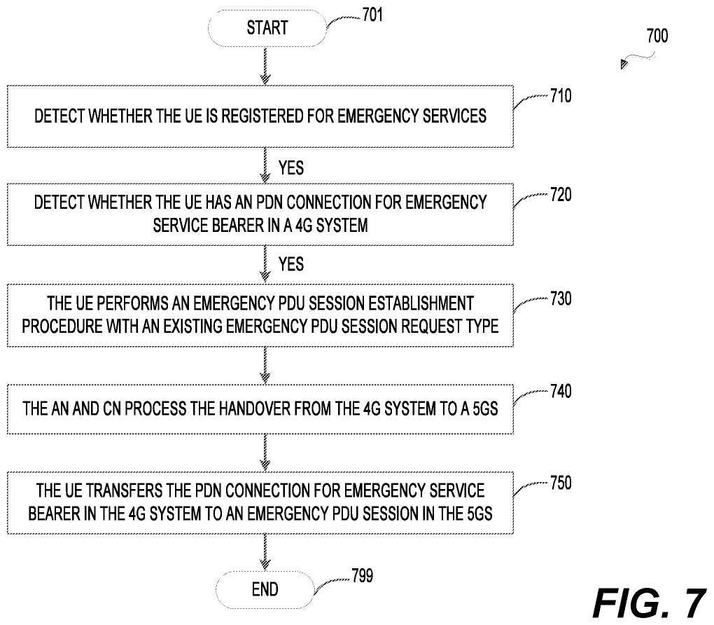

FIG. 7 is a flowchart showing an exemplary PDN connection transfer process 700 according to an embodiment of the disclosure. The UE can transfer an established PDN connection for an emergency bearer service in the EPS to an emergency PDU session in the 5GS. In the FIG. 7 example, the established PDN connection for the emergency bearer service is in a 3GPP access (e.g., LTE) of the EPS and the emergency PDU session is also in a 3GPP access (e.g., 5G NR) of the 5GS. The process 700 can start from 701 and proceed to 710.

At 710, the UE can detect whether the UE is registered for the emergency services. For example, as shown in the FIG. 1 example, the processing circuitry 113 of the UE 110 can trigger the detection module 115 to execute the program instructions stored in the memory 117 to check whether the UE 110 is registered for the emergency services in the 5GS. If yes, the process 700 can then proceed to 720. If not, the processing circuitry 113 of the UE 110 can trigger the registration module 114 to execute the program instructions stored in the memory 117 to register the UE 110 in the 5GS via the 5G 3GPP access 122. Then process 700 can proceed to 720.

At 720, when the UE is registered for the emergency services, the UE can further detect whether the UE has the established PDN connection 170 for the emergency bearer service. For example, as shown in the FIG. 1, the processing circuitry 113 of the UE 110 can trigger the detection module 115 to detect whether the UE 110 has registered in the EPS and has the established PDN connection 170 for the emergency bearer service by executing the program instructions stored in the memory 117. When the UE 110 has the established PDN connection 170 for the emergency bearer service, the process 700 can then proceed to 730.

At 730, when the UE is registered for the emergency services and has the established PDN connection for the emergency bearer service in the EPS, the UE can transfer the established PDN connection for the emergency bearer service in the EPS to the emergency PDU session in the 5GS. For example, as shown in the FIG. 1, the processing circuitry 113 of the UE 110 can trigger the PDU operation module 116 to execute the program instructions stored in the memory 117 to perform an emergency PDU session establishment procedure so that the UE 110 can transfer the established PDN connection 170 for the emergency bearer service in the EPS to the emergency PDU session 160 in the 5GS.

Specifically, the PDU operation module 116 can generate a PDU session establishment request with an existing emergency PDU session request type (e.g., request type is set to “existing emergency PDU session”), which indicates the emergency PDU session establishment request is to transfer the established PDN connection 170 for the emergency bearer service in the 4G 3GPP access 123 to the emergency PDU session 160 in the 5G 3GPP access 122. The RF module 112 can further process the PDU session establishment request and transmit the PDU session establishment request via the antenna 111 as wireless signals. The process 700 can then proceed to 740.

At 740, the AN can receive the PDU session establishment request and forward it to the CN. Upon the reception of the PDU session establishment request from the UE, the CN can process the PDU session establishment request with the AN. For example, as shown in the FIG. 1, upon the reception of PDU session establishment request, the 5GC 131 and the EPC 132 can work with the AN 120 to perform PDU session handover from the EPS to the 5GS. The process 700 can then proceed to 750.

At 750, the UE can transfer the established PDN connection 170 for the emergency bearer service in the EPS to the emergency PDU session 160 in the 5GS. For example, as shown in the FIG. 1, when the 5GC 131 and the EPC 132 accept the PDU session establishment request from the UE 110 and finish the PDU session handover from the EPS to the 5GS, the UE 110 can transfer the established PDN connection 170 for the emergency bearer service in the 4G 3GPP access 123 to the emergency PDU 160 session in the 5G 3GPP access 122. Then the process 700 can proceed to 799 and terminate.

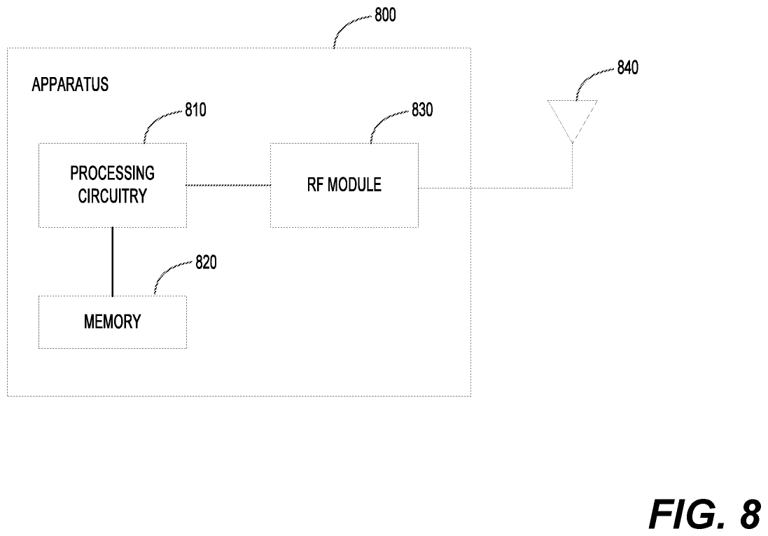

FIG. 8 shows an exemplary apparatus 800 according to embodiments of the disclosure. The apparatus 800 can be configured to perform various functions in accordance with one or more embodiments or examples described herein. Thus, the apparatus 800 can provide means for implementation of techniques, processes, functions, components, systems described herein. For example, the apparatus 800 can be used to implement functions of the UE 110 in various embodiments and examples described herein. The apparatus 800 can be a general purpose computer in some embodiments, and can be a device including specially designed circuits to implement various functions, components, or processes described herein in other embodiments. The apparatus 800 can include processing circuitry 810, a memory 820, a radio frequency (RF) module 830, and an antenna 840.

In various examples, the processing circuitry 810 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 810 can be a central processing unit (CPU) configured to execute program instructions to perform various functions and processes described herein. Accordingly, the memory 820 can be configured to store program instructions. The processing circuitry 810, when executing the program instructions, can perform the functions and processes. The memory 820 can further store other programs or data, such as operating systems, application programs, and the like. The memory can include transitory or non-transitory storage medium. The memory 820 can include a read only memory (ROM), a random access memory (RAM), a flash memory, a solid state memory, a hard disk drive, an optical disk drive, and the like.

The RF module 830 receives processed data signal from the processing circuitry 810 and transmits the signal in a beam-formed wireless communication network via an antenna 840, or vice versa. The RF module 830 can include a digital to analog convertor (DAC), an analog to digital converter (ADC), a frequency up convertor, a frequency down converter, filters, and amplifiers for reception and transmission operations. The RF module 830 can include multi-antenna circuitry (e.g., analog signal phase/amplitude control units) for beamforming operations. The antenna 840 can include one or more antenna arrays.

The apparatus 800 can optionally include other components, such as input and output devices, additional or signal processing circuitry, and the like. Accordingly, the apparatus 800 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. An apparatus, comprising processing circuitry configured to:
detect whether user equipment (UE) is registered for emergency services via a first access type in a wireless communication system;
establish a new emergency protocol data unit (PDU) session when the UE is registered, but without an established emergency PDU session; and
transfer, when the UE is registered and has the established emergency PDU session in the first access type, the established emergency PDU session in the first access type to a second emergency PDU session in a second access type by:
sending a request to perform a PDU session establishment procedure to transfer the established emergency PDU session; or
performing a service request procedure to transfer the established emergency PDU session.

2. The apparatus of claim 1, wherein the comprising processing circuitry is further configured to:
detect whether the UE has an established packet data network (PDN) connection for an emergency bearer service in a fourth generation (4G) system;
perform an emergency PDU session establishment procedure with an existing emergency PDU session request type when the UE has the established PDN connection for the emergency bearer service; and
transfer the established PDN connection for the emergency bearer service in the 4G system to an emergency PDU session in a fifth generation (5G) system.

3. The apparatus of claim 1, wherein detecting whether the user equipment (UE) is registered for emergency services via the first access type in the wireless communication system further includes preventing a PDU session being established for normal services in the first access type when the UE is registered for emergency services.

4. The apparatus of claim 1, wherein establishing the new emergency PDU session further includes performing an emergency PDU session establishment procedure with an initial emergency request type when the UE does not have the established emergency PDU session.

5. The apparatus of claim 1, wherein transferring the established emergency PDU session in the first access type to the second emergency PDU session in the second access type further includes:
sending an emergency PDU session establishment request with an existing emergency PDU session request type; and
transferring the established emergency PDU session from the first access type to the second access type.

6. The apparatus of claim 1, wherein transferring the established emergency PDU session in the first access type to the second emergency PDU session in the second access type further includes performing
a network triggered service request procedure to transfer the established emergency PDU session from the first access type to the second access type; or
a UE triggered service request procedure to transfer the established emergency PDU session from the first access type to the second access type.

7. The apparatus of claim 1, wherein transferring the established emergency PDU session in the first access type to the second emergency PDU session in the second access type further includes:
transferring the established emergency PDU session in a 3GPP access to the second emergency PDU session in a non-3GPP access; or
transferring the established emergency PDU session in a non-3GPP access to the second emergency PDU session in a 3GPP access.

8. A method, comprising:
detecting whether user equipment (UE) is registered for emergency services via a first access type in a wireless communication system;
establishing a new emergency protocol data unit (PDU) session when the UE is registered, but without an established emergency PDU session; and
transferring, when the UE is registered and has the established emergency PDU session in the first access type, the established emergency PDU session in the first access type to a second emergency PDU session in a second access type by:
sending a request to perform a PDU session establishment procedure to transfer the established emergency PDU session; or
performing a service request procedure to transfer the established emergency PDU session.

9. The method of claim 8 further comprises:
detecting whether the UE has an established packet data network (PDN) connection for an emergency bearer service in a fourth generation (4G) system;
performing an emergency PDU session establishment procedure with an existing emergency PDU session request type when the UE has the established PDN connection for the emergency bearer service; and
transferring the established PDN connection for the emergency bearer service in the 4G system to an emergency PDU session in a fifth generation (5G) system.

10. The method of claim 8, wherein detecting whether the user equipment (UE) is registered for emergency services via the first access type in the wireless communication system further comprises preventing a PDU session being established for normal services in the first access type when the UE is registered for emergency services.

11. The method of claim 8, wherein establishing the new emergency PDU session further comprises performing an emergency PDU session establishment procedure with an initial emergency request type when the UE does not have the established emergency PDU session.

12. The method of claim 8, wherein transferring the established emergency PDU session in the first access type to the second emergency PDU session in the second access type further comprises:
sending an emergency PDU session establishment request with an existing emergency PDU session request type; and
transferring the established emergency PDU session from the first access type to the second access type.

13. The method of claim 8, wherein transferring the established emergency PDU session in the first access type to the second emergency PDU session in the second access type further comprises performing:
a network triggered service request procedure to transfer the established emergency PDU session from the first access type to the second access type; or
a UE triggered service request procedure to transfer the established emergency PDU session from the first access type to the second access type.

14. The method of claim 8, wherein transferring the established emergency PDU session in the first access type to the second emergency PDU session in the second access type further comprises:
transferring the established emergency PDU session in a 3GPP access to the second emergency PDU session in a non-3GPP access; or
transferring the established emergency PDU session in a non-3GPP access to the second emergency PDU session in a 3GPP access.

15. A non-transitory computer readable medium storing instructions which, when executed by a processor, cause the processor to perform the steps of:
detecting whether user equipment (UE) is registered for emergency services via a first access type in a wireless communication system;
establishing a new emergency protocol data unit (PDU) session when the UE is registered, but without an established emergency PDU session; and
transferring, when the UE is registered and has the established emergency PDU session in the first access type, the established emergency PDU session in the first access type to a second emergency PDU session in a second access type by:
sending a request to perform a PDU session establishment procedure to transfer the established emergency PDU session; or
performing a service request procedure to transfer the established emergency PDU session.

16. The non-transitory computer readable medium of claim 15, wherein the instructions which, when executed by a processor, further cause the processor to perform the steps of:
detecting whether the UE has an established packet data network (PDN) connection for an emergency bearer service in a fourth generation (4G) system;
performing an emergency PDU session establishment procedure with an existing emergency PDU session request type when the UE has the established PDN connection for the emergency bearer service; and
transferring the established PDN connection for the emergency bearer service in the 4G system to an emergency PDU session in a fifth generation (5G) system.

17. The non-transitory computer readable medium of claim 15, wherein the instructions being executed by the processor further cause the processor to prevent a PDU session being established for normal services in the first access type when the UE is registered for emergency services.

18. The non-transitory computer readable medium of claim 15, wherein the instructions being executed by the processor to establish the new emergency PDU session, further cause the processor to perform an emergency PDU session establishment procedure with an initial emergency request type when the UE does not have the established emergency PDU session.

19. The non-transitory computer readable medium of claim 15, wherein the instructions being executed by the processor to transfer the established emergency PDU session in the first access type to the second emergency PDU session in the second access type, further cause the processor to perform the steps of:
sending an emergency PDU session establishment request with an existing emergency PDU session request type; and
transferring the established emergency PDU session from the first access type to the second access type.

20. The non-transitory computer readable medium of claim 15, wherein the instructions being executed by the processor to transfer the established emergency PDU session in the first access type to the second emergency PDU session in the second access type, further cause the processor to perform:
a network triggered service request procedure to transfer the established emergency PDU session from the first access type to the second access type; or
a UE triggered service request procedure to transfer the established emergency PDU session from the first access type to the second access type.
